(19) United States
(12) Patent Application Publication
(10) Pub. No.: US 2002/0002678 A1
(43) Pub. Date: Jan. 3, 2002

(54) INTERNET AUTHENTICATION TECHNOLOGY

(76) Inventors: STANLEY T. CHOW, NEPEAN (CA); HAROLD J. JOHNSON, NEPEAN (CA); YUAN GU, KANATA (CA)

Correspondence Address: HAYES SOLOWAY HENNESSEY GROSSMAN &, HAGE, 175 CANAL STREET, MANCHESTER, NH, 031012335

(21) Appl. No.: 09/134,731

(22) Filed: Aug. 14, 1998

(51) Int. Cl. H04L 9/00

(52) U.S. Cl. 713/169

(57) ABSTRACT

The present invention relates generally to cryptography, and more specifically, to secure authentication of a First Computer Program to a Second Computer Program. The approaches known in the art require that secure data positively identifying Client accounts be stored at a central location, either the Server or a Certifying Authority, requiring large overheads of memory and computational power, and presenting obvious and high-value targets for attacks. The invention provides a means of authenticating Clients to Servers without requiring confidential data to either be stored at the Server, or transmitted to the Server. The Client generates a series of one-time passwords by successive iterations of a non-reversible function on a seed value. The last value in the series is then sent to the Server to establish an account. When the Client wishes to log on to his account, he sends the previous value in the non-reversible series as his password. The Server can easily authenticate the Client by executing the same non-reversible function on the password and verifying that is equal to the previous password. However, given such a one-time password, there is no practical means for generating a prior value in the non-reversible series. Therefore, even if the password is intercepted or the Server data accessed, there is no useful information available in either the transmission or the central storage.

The present invention relates generally to cryptography, and more specifically, to secure authentication of a First Computer Program to a Second Computer Program.

### BACKGROUND OF THE INVENTION

It is well known that data communication networks such as the internet, Wide Area Networks (WANs) and Local Area Networks (LANs), present tremendously efficient means of organizing and distributing computerized data. However, without proper access control, the more accessible and flexible a network becomes, the less secure it becomes. Therefore, there is a need to control access to certain network resources without compromising the power of the communications network.

In the state of the art, security is generally provided by limiting access to Clients who possess accounts and passwords authorized by a Server or System Administrator. This process is described as authentication. Broadly speaking, there are currently two approaches to authentication of a Client to a Server: authentication at the Server, and authentication by a third party, called a Certification Authority.

Both of these approaches require that secure data positively identifying the Client accounts be stored in a central location. Such central control systems therefore require large overheads of memory and computational power to provide quick authentication and access for the Clients. The more complex the authentication technique and larger the number of Clients, the slower the access time and the larger the infrastructure the central authenticator must provide. Also, because this confidential data is accessible from the communication network to some extent, and with such a high volume of confidential data, such central locations become obvious and high-value targets for attacks, necessitating a high level of internal security.

The fact that the central authenticator will have finite memory and computational resources means that the level of security will have a finite limit. A Client may not be able to request a more complex policy, such as increasing the frequency of password changes, or length of passwords. And if such changes can be made, they would likely be at increased cost to the Client due to the increased overhead at the central authenticator.

Furthermore, with confidential Client information stored at a central location, the Server or System Administrator could impersonate any Client or use their personal data for other purposes such as selling as marketing data.

The more Servers that a Client must provide confidential data to, the greater the possibility of his confidential data being violated. If a Client is using a biometric password such as a voice-, eye- or finger-print that is intercepted while in transmission or mined from a central location by an intruder, then the Client can no longer use this means of authentication.

To limit the dispersion of his private data, a Client may use a single Certification Authority for authentication. However, if a Client then wishes to access a Server which uses a different Certification Authority, bi-directional authentication must be performed between the Client and the Client's Certification authority, between the two Certification Authorities and then between the Server and the Server's Certification Authority. This cross-domain authentication is expensive, time consuming, and increases the possibility of either intrusion or unsuccessful authentication.

Because all authentication is done at either the Server or Certification Authority, secure Client data must be transmitted over the insecure network. Even if the data are in an encrypted form, they are still vulnerable to attack. As noted above, interception of biometric data for example, can prevent a Client from ever using that biometric again.

Central authentication also results in a central point of failure. If the Certifying Authority is down, then none of the Clients may access any of the Servers served by the Certifying Authority. Such services often have redundant hardware to reduce the possibility of such a failure, but such redundancies come at considerable incremental cost, and only reduce, but not eliminate the possibility of a complete failure of the system.

Typically, authentication is done via passwords, but that is not secure since people will often write down the password, particularly when they have to deal with a large number of Servers or complex passwords. There is also a problem in that if the same password is reused, others may steal the password by interception or “shoulder-surfing”. Systems which use the same passwords for an extended period of time are particularly vulnerable to such attack.

As well, the existing systems generally require manual intervention for corrections and modifications. Lost passwords, for example, generally require the User to contact the Server and set up a new account.

The internet presents further difficulties in the implementation of one time passwords because of the low quality of service. If the system relies on a predetermined sequence of passwords and an internet message is lost, generally the User must manually contact the Server and set up a new account.

None of the existing systems provide a straightforward implementation for delegation of access either. Typically, a first User can only delegate rights to a second User by giving his password to the second User, allowing him to masquerade as the first. The existing systems do not allow a paper trial of delegation to be maintained, and it is impossible to revoke the delegation. As well, the Server can not identify the second User as a delegate, and therefore can not control his access.

There is therefore a need for a secure means of authentication which addresses the problems outlined above. This design must be provided with consideration for the memory and computational resources of the Server, time required for authentication, and complexity and reliability of the design.

### SUMMARY OF THE INVENTION

It is therefore an object of the invention to provide a means of authenticating a First Computer Program to a Second Computer Program.

One aspect of the invention is broadly defined as a method of authenticating communication between a First Computer Program and a Second Computer Program, wherein both the First Computer Program and the Second Computer Program are operable to execute a like non-reversible function, the First Computer Program has established an account with the Second Computer Program by transmitting an initial value to the Second Computer Program calculated by at least one iteration of a non-reversible function on a stored seed value and the Second Computer Program is operable to store the last transmitted password or initial value as a reference value, the method comprising the step within the First Computer Program of: responding to an authentication challenge from the Second Computer Program by transmitting to the Second Computer Program a password calculated by fewer iterations of the non-reversible function on the stored seed value than used to calculate the reference value, and storing the quantity of the fewer iterations.

### BRIEF DESCRIPTION OF THE DRAWINGS

These and other features of the invention will become more apparent from the following description in which reference is made to the appended drawings in which:

FIG. 1 presents a flow chart of the general method of Client authentication in a manner of the invention;

FIG. 2 presents a physical layout of a typical computer Client/Server network, as known in the art;

FIG. 3 presents a flow chart for operation of self-authentication of the User to the Client Software in a manner of the invention;

FIG. 4 presents a flow chart for operation of authentication between the Client Software and the Server Software, by the Client Software in a manner of the invention;

FIG. 5 presents a flow chart for operation of the Client Software in an Internet Browser environment, in a manner of the invention; and

FIG. 6 presents a flow chart for operation of Server Software in a manner of the invention.

### DETAILED DESCRIPTION OF PREFERRED EMBODIMENTS OF THE INVENTION

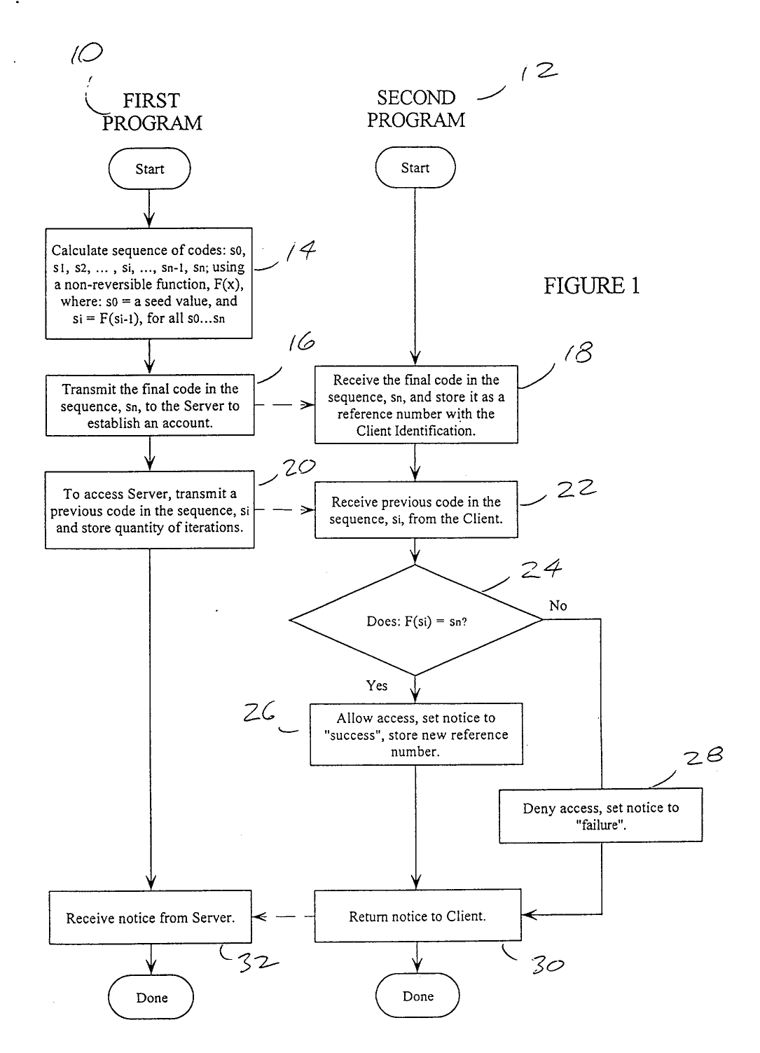

A methodology which addresses the objects outlined above is presented as a flow chart in FIG. 1. This flow chart presents a method of authenticating communication between a First Computer Program 10 and a Second Computer Program 12, wherein both the First Computer Program 10 and the Second Computer Program 12 are operable to execute a like non-reversible function. The First Computer Program 10 calculates an initial value sₙ by executing the non-reversible function on a stored seed value at least one time at step 14. The First Computer Program 10 then establishes an account with the Second Computer Program 12 by transmitting the initial value sₙ to the Second Computer Program 12 at step 16; the Second Computer Program 12 being operable to store the last transmitted password or initial value as a reference value, as shown at step 18.

The actual authentication is then effected by the First Computer Program 10 responding to an authentication challenge from the Second Computer Program 12 by transmitting to the Second Computer Program 12 a password calculated by fewer iterations of the non-reversible function on the stored seed value than used to calculate the reference value, and storing the quantity of the fewer iterations, as shown at step 20.

The Second Computer Program 12 receives the password from the First Computer Program 10 at step 22. If the password is successfully authenticated by the non-reversible function operating upon it being equal to the reference value, as shown as step 24, then the Second Computer Program 12 authenticates the First Computer Program to the Second Computer Program at step 26 and stores the password as the new reference value.

If the authentication at step 24 is not successful, access is denied at step 28. The second program then transmits notice to the First Computer Program of whether authentication was or was not successful at step 30, and the First Computer Program receives the notice at step 32 and proceeds with the secured session if authenticated.

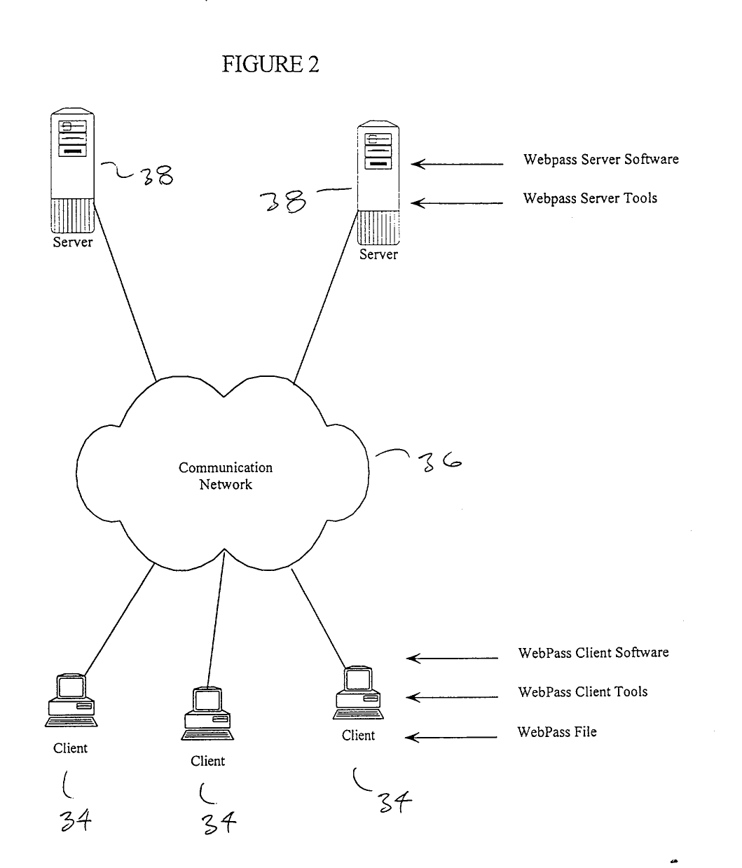

In FIG. 2 a physical layout of a typical computer network is presented. A number of Client Computers 34 are connected to a Communication Network 36, which in turn is connected to a number of Servers 38. The Communication Network 36 may consist of one or a combination of an internet network, Wide Area Network (WAN), Local Area Network (LAN), routers, firewalls, dedicated connections or similar data communication networks and their associated protocols as known in the art. In the simplest case, this Communication Network 36 may consist of a direct connection between two computers.

The invention will be described with respect to a general situation of a Client Computer 34 being authenticated for access to a Server 38 via the Communication Network 36. The First Computer Program 10 as described above, is installed and operating on Client Computer 34, and the Second Computer Program 12 is installed and operating on a Server 38. However, it would be clear to one skilled in the art that the invention may be applied to a broad range of physical components, and that in fact both the First Computer Program 10 and the Second Computer Program 12 could reside in the same computer, or on portable diskettes.

For example, the First Computer Program 10 could be stored on a floppy diskette and be used to authenticate to the Second Computer Program 12 stored on a laptop or desktop computer. This would allow a User to prevent access to the laptop without the diskette.

Another common implementation of the invention would be a Communication Network 36 comprising a LAN servicing the Client Computer 34, and an internet network connecting it to a Server 38, where the First Computer Program 10 is installed and operating on a Client Computer 34, and the Second Computer Program 12 is installed and operating on a Server 38. This would allow secure authentication over the internet.

The First Computer Program 10 and the Second Computer Program 12 are operable to execute a like non-reversible or hash function. This function may be based on one known in the art, such as MD5 from RSA or the SHA algorithm from NIST. The invention relies on the non-reversible property of such functions; that given the function and a product of the function, it is very difficult to calculate the operand.

For example, using a simple non-reversible function such as the additive congruential pseudo-random number generator known in the art:

xᵢ₊ᵢ=(9731 xᵢ+12357) mod 997

where “mod” is the modulus function which yields the remainder when (9731 xᵢ+12357) is divided by 997, and 9731, 12357 and 997 are arbitrary constants, given a seed value of x₀=5, a series be generated as follows:

x₁=9731 * 5+12357 mod 997=61012 mod 997=195

x₂=9731 * 195+12357 mod 997=1909902 mod 997=647

x₃=9731 * 647+12357 mod 997=6308314 mod 997=295.

Even knowing a value of xᵢ and the constants 9731, 12357 and 997, it is very difficult to determine the value of xᵢ₋₁. To test each possible equation to find the value of xᵢ₋₁ one would have to calculate as many as 997 equations.

If the constants and xᵢ were in the order of 128 bits long, then as many as 2¹²⁸ equations would have to be calculated. Even with a computer executing 1 billion calculations per second, it would take 1×10²² years, or 2,000,000,000,000 times the lifetime of the universe, to test all the possible equations.

This simple function is given for the purpose of illustration only. As it is linear, it is straightforward to solve for the operand, making it unsuitable for cryptographic use. However, there are more sophisticated non-reversible functions known in the art for which no practical way of performing reverse calculations has yet to be devised. The MD5 and SHA algorithms are well known examples of such functions.

The First Computer Program 10 uses this non-reversible function to create a series of passwords from s₀ to sₙ, by successively executing the function on a seed value s₀. As noted in step 14 of FIG. 1, each sᵢ, is calculated by executing the non-reversible function on the previous password sᵢ₋₁. It is a property of the non-reversible function that there is no practical means for calculating sᵢ₋₁ from knowledge of the non-reversible function and the last password sᵢ₋₁. Therefore, successively previous values of s can be used as passwords because they can not be generated from knowledge of old passwords.

Of course, it is quite easy to verify that a new password is in the same sequence as the previous value by executing the non-reversible function on the new password and comparing it the previous value. This is the authentication test that is performed by the Second Computer Program 12 at step 24.

This sequence of passwords s₀ . . . sₙ may be stored by the First Computer Program, or just the seed value which may be used to regenerate the sequence when required. In fact, incremental iterations of the sequence could be used to replace the seed value, though would this reduce the number of available passwords.

The seed value s₀, may be created a number of ways, including use of a random number generator, accessing internal computer identification data, or using a character string entered by a User.

At step 16 of FIG. 1, it has been indicated that the final code in the sequence, sₙ, is to be transmitted to the Second Computer Program 12, but clearly it is not required that the initial value sent to the Second Computer Program 12 be the final code in the sequence. Any value in the sequence could be transmitted as the initial value, provided that subsequent passwords are the result of previous iterations of the non-reversible function to exploit the non-reversible property of the function.

An account may be established in a number of ways as known in the art, as long as the initial value is received by the Second Computer Program 12 in some manner that it may be stored as a reference for that Client account as shown at step 16. The Second Computer Program 12 continually replaces the reference value with new passwords so that it contains the most recent password or initial value as a reference value as shown at step 18.

The actual authentication is then effected by the First Computer Program 10 responding to an authentication challenge from the Second Computer Program 12 by transmitting to the Second Computer Program 12 a password calculated by fewer iterations of the non-reversible function on the stored seed value than used to calculate the reference value, and storing the quantity of the fewer iterations, as shown at step 20.

By storing the quantity of iterations used to create the current password, assurance can be made that future passwords are generated with fewer iterations of the non-reversible function.

In the simplest form of the protocol, each password would be generated by an immediately preceding iteration of the non-reversible function. In this system, if a message was lost, for example due to network trouble, the Server 38 would refuse to ever authenticate the Client account again. This problem could be prevented by employing one of the following methods:

1. When authenticating, send the quantity of iterations used to generate the password to the Server 38. The Server 38 could compare this to the quantity of iterations used to generate the reference value, and be able to handle gaps due to missing messages, by increasing the number of iterations of the non-reversible function performed on the password. This is most useful for simple one-way transactions over slow links.

2. The Server 38 can automatically try a window of a predetermined size so that if the new password is within that many iterations of the previous reference value, then it is accepted. This is good if the network is very reliable and errors are rare.

3. Blindly use one-hash-at-a-time when the Server 38 refuses to authenticate, in an attempt to re-synchronize the sequence between the Server and Client.

4. Re-key the sequence by authenticating using a higher-level sequence. More details are provided hereafter regarding such multiple sequences. This method is best suited for high volume transactions over reliable networks. The Second Computer Program 12 then receives the password from the First

Computer Program 10 at step 22. If the password is successfully authenticated by the non-reversible function operating upon it being equal to the reference value as shown as step 24, then the Second Computer Program 12 authenticates the First Computer Program to the Second Computer Program at step 26 and stores the password as the new reference value.

The operation of the Second Computer Program 12 at step 24 must be coordinated with the security policy of the First Computer Program 10 as outlined above. Clearly, additional protocols could also be employed without compromising the invention.

If the authentication at step 24 is not successful, then an indication is made within the Second Computer Program 12 that access is to be denied at step 28. The Second Computer Program 12 then transmits notice to the First Computer Program of whether authentication was or was not successful at step 30, and the First Computer Program 10 receives the notice at step 32 and proceeds with its secured session if successfully authenticated.

Clearly, the steps of 26, 28, and 30 need not be executed in the same manner as described. One skilled in the art would know a variety of methods for storing and communicating whether the authentication attempt has been successful or not.

This method provides a number of advantages over the prior art. Generally speaking, the Server 38 only verifies the password against non-confidential data, and does not have to authenticate it against secure data as in the systems known in the art. Therefore the Server 38 does not need to store private information for each Client 34, and does not become a high-value target for attacks.

Because so little information must be stored at the Server 38, and because the processing is so simple and straightforward, very little memory and computational overhead is required. This allows Servers 38 to be implemented without a huge infrastructure, and allows them to be easily scalable in the number of Users and applications.

Because each Server 38 handles its own Clients 34, there is no need for a Certifying Authority, and because no Server 38 acts as a Central Authority for a given Client 34, there is no central point of failure.

In combination with the additional options described below, the invention provides for an easily administrated security system.

The invention allows all of the secrets to be stored in the Client Software, so there is no need to store secrets at a remote location. This means that the Server 38 or System Administrator cannot impersonate any Users, and does not need to be secure to protect confidential User information or passwords.

Because secure Client data does not have to be transmitted over an insecure network, not even in an encrypted form, there are no privacy concerns. As well, security of the network is no longer as important since there are no personal secrets to be gained during transmission.

The invention is preferably implemented so that each password can only be used once. Therefore, there is no point in intercepting a password because they can not be used.

Because no Certifying Authority required, the invention is cross-domain without requiring multiple authentications. Any Client 34 can establish direct access to any Server 38, provided authorization is granted.

In the invention, it is preferred that the Client 34 first authenticate himself to his own computer in a step described hereafter as self-authentication. Because self-authentication is done on the Client 34 computer, elaborate or slow forms of authentication may be used since they impose no load on the Server 38 or communication network 36. As well, the Client 34 may impose complex policies such as frequent changes to passwords with no cost to the Server 38.

The invention also accommodates separate security concerns easily, because the Clients 34 and Servers 38 each control their own security administration.

The invention also provides for “Just-in-time” security, which means that the Client Software need only ask the User to self-authenticate to a higher level if the User is trying to access a Server at a higher level of security, and not just going into a different Server 38. That is, if the User has authenticated to his Client Software at the highest level of security, the Client Software may allow access to any Server 38 the User wishes to access. If the User self-authenticates to the lowest level of security, then the Client Software will require the User to authenticate to the necessary level if the User attempts to access a Server 38 with a higher security level.

The invention also allows for each password to only be used once, described as a One-Time-Password. This prevents intercepted passwords from being used to gain access, and also provides for non-repudiation. Non-repudiation means that a password is so unique that the Server 38 can show that access was made by the User; that is, the User can not repudiate his access. This allows the invention to be applied to “milli-cent” commerce, as well as to transactions of high dollar amounts.

Since the Client Software file is only a set of protocol instructions and does not contain any secure information, there is no risk in its electronic transmission. A new User can download his Client Software from a public website, have it transmitted by E-mail or purchased by physical mail.

As well, electronic transmission of Server 38 credentials need not be secure. Once a User obtains the Client Software, he is able to establish access to a new Server 38 securely, with only electronic access.

As outlined below, the invention allows such additional options as third party introduction/brokering for initial authentication and/or per-transaction authentication, handling of lost Passwords by the User, and removal of fired employees by the System Administrator.

The invention can also be implemented to generate passwords which are very long and totally random, and the User does not have to remember them.

As well, the invention is easily employed to delegate access to other Users. When a first User delegates some rights to a second User, the second User is automatically authenticated and tracked as the second User; while in the prior art the first User gives his password to the second and thereafter the second User is masquerading as the first. Because the second User is identifiable, it is easy for either the first User or the System Administrator to control and monitor his access.

In the preferred embodiment of the invention, it is envisioned that the invention will provide a method of authenticating communication between a first computer and a second computer, and also allowing delegation to a third computer, wherein both the first computer and the second computer are operable to execute a like non-reversible function. The first computer will establish an account with the second computer by transmitting a plurality of initial values to the second computer calculated by at least one iteration of a non-reversible function on a plurality of stored seed values, and first, second and third computers are linked by an internet communications protocol network.

The method executed in the first computer first comprises the step of responding to an authentication challenge from the second computer by successively transmitting via the internet communications protocol network to the second computer a password calculated by one fewer iterations of the non-reversible function on one of the plurality of stored seed values than used to calculate the plurality of initial values, and storing the quantity of the one fewer iterations for the respective one of the plurality of stored seed values.

If the first computer receives a request for delegation of access to the second computer from a third computer, the first computer will respond by transmitting to the third computer via the communications network a password corresponding to one fewer iterations of the non-reversible function than used to calculate the reference value. Further details of delegation are described hereafter.

In the preferred embodiment, when all of the passwords have been exhausted, the First Computer Program 10 at the Client 34 computer will calculate a plurality of new seed values by multiple iterations of a non-reversible function on an initial seed value. These resulting new reference values will be transmitted via the internet communications protocol network to the Second Computer Program 12.

It is preferred that the difficulty of passwords being lost, de-synchronizing the sequence of passwords between the Client 34 from the Server 38, be remedied by the First Computer Program 10 transmitting via the internet communications protocol network to the Second Computer Program 12 the quantity of iterations of the non-reversible function used to calculate the password.

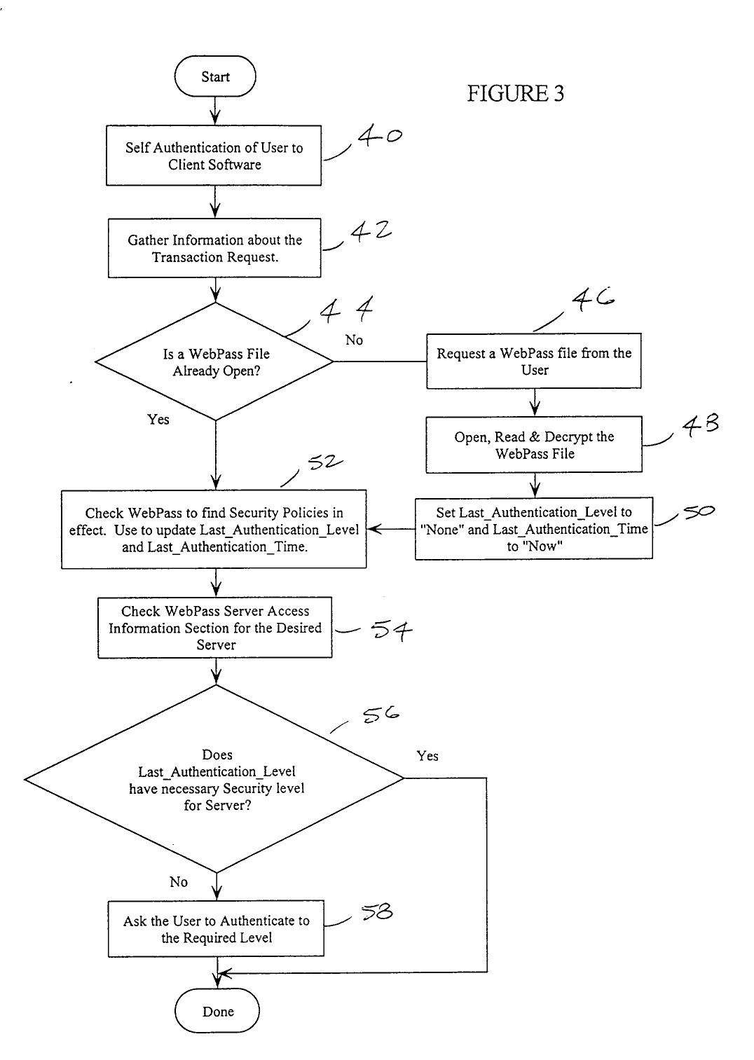

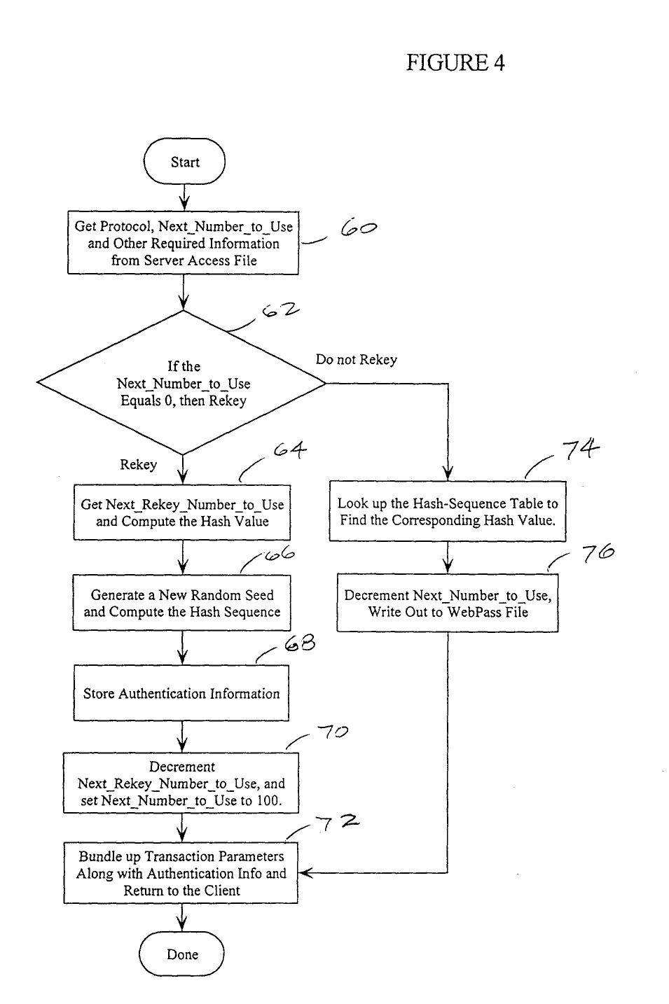

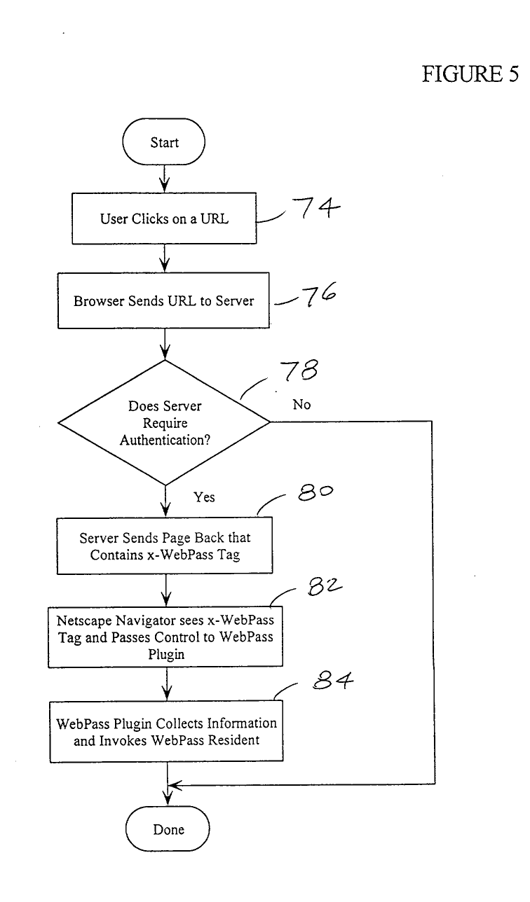

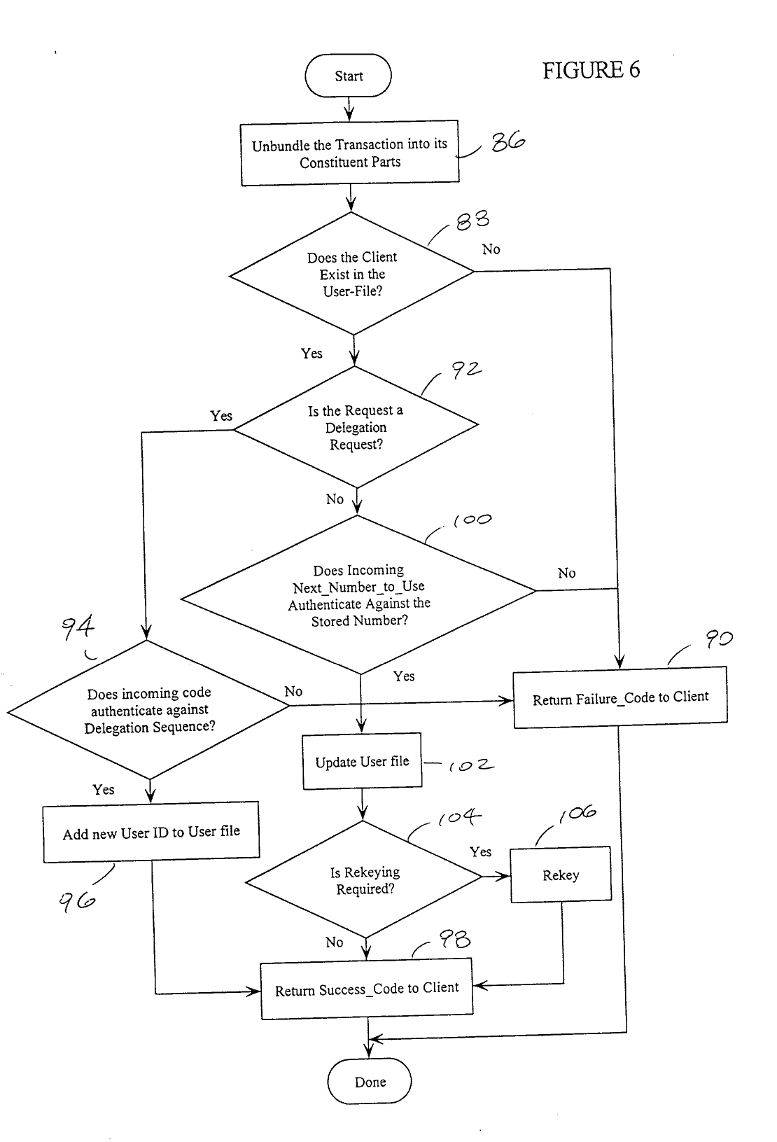

It is envisioned that the preferred embodiment of the invention will be as outlined in FIGS. 3-6. In general, the User authenticates himself to his Client Software as per FIG. 3, then the Client Software authenticates each transaction to the Server Software on behalf of the User as outlined in FIG. 4. FIG. 5 describes the particular application of the Client Software in the environment of an Internet Browser, while in FIG. 6 describes the operation of the Server Software.

It is proposed that the software for the invention be arranged into five files:

1. Password Data File

This file contains all the secrets used for authentication. Generally a single Password Data File is provided per User that may talk to many Servers 38, but a User may have one Password Data File per Server 38.

2. Client Software

The Software that is resident on the Client 34 Computer. This Software can include pieces from different Users and can contain multiple levels of encryption. This software may be provided as a “plug-in” for an internet browser such as Netscape Navigator/Communicator or Microsoft Internet Explorer.

3. Server Software

The Software that is resident on the Server 38. This is typically in the form of a “Library” and linked into the application code on the Server 38. This code is responsible for actually granting access as well as maintaining Access Control List (ACL) information.

4. Client Tools

Software tools that can be run anywhere. It is used by Users to manage their Password Data Files, delegate authority and to perform other maintenance operations.

5. Server Tools

Software tools to control and administer the operation of the Server Software.

Further details regarding the operation and options available for these files will be described following.

The process of authenticating the User to the Client Software as outlined in FIG. 3 is executed as part of step 20 shown in FIG. 1. Firstly, the User provides an initial password to his Client Software, at step 40. This may be done in a number of ways, for example, by use of a password or biometric data such as a voice-, eye- or finger-print. The Client Software will contain a corresponding match to the password which it uses to either accept or reject the self-authentication attempt. The Client 34, or his local System Administrator, will have control over the level of local security.

Note that while the. Servers 38 do not participate in the User's authentication of himself to his Client Software, the Servers 38 can still dictate the security policy. For example, a Print-Server may define itself to be low-security and allow access with a 6 character password that is updated once a month. On the other hand, a Human Resources/Salary Server may define itself to be high security and dictate that passwords used to authenticate the User to the Client Software must be 12 characters long and changed every week.

Note that the Client Software may track the level of self-authentication done by the User and may apply time-outs and other policies as dictated by the different Servers 38. For example, if the User used a voice-print to authenticate himself, the Client Software generally would not require the User to re-authenticate to access lower security Servers 38. This is described as “Just-In-Time” authentication.

After the User has been authenticated to his Client Software, transactions between the Client 34 and Server 38 may then be authenticated. This is typically initiated by the Client 34 in an attempt to access a Server 38, indicated as step 42. The nature of the request and particular details of information required are dependent on the communication network and protocol between the Client 34 and Server 38, and the nature of the request. In general, this information may comprise such data as the Client 34 and Server 38 identifications and locations, and a description of the data being sought.

At step 44, the Client Software will determine whether a Password Data File is already open that is appropriate to the request being made at step 42. If such a Password Data File is not open, the Client Software will query the Client 34 to identify or-create such a file at step 46.

Once a Password Data File has been identified or created, it will generally be stored on the hard disk or a floppy diskette that is inserted on request. It is also possible to have more secure storage that communicates via various channels, such as a hand held computer that communicates via an Infra-Red Communications port, or other hardware devices communicating over the serial port.

Once the Password Data File has been identified, it is opened, read and decrypted as shown at step 48. The particulars of the security policy may require us to load a company-specific DLL (Dynamic Load Library) to do the decryption and subsequent encryption for the Password Data File.

Two flags are now set as shown at step 50. Firstly, the variable last_authentication_level is set to “none” to indicate that authentication is initially being made at the lowest security level, and the variable last_authentication_time is set to “now”, to store the present time, allowing time-outs to be used.

At step 52, the Password Data File is checked to determine the security policies in effect. As outlined below, it is intended that such information be stored in a section of the Password Data File called Owner_info. The security policies which are identified will be applied to update the values of the variables last_authentication_level and last_authentication time.

The Password Data File will then be queried for the Server_access_info associated with the Server 38 that the Client 34 wishes to access at step 54. If the current security level, last_authentication_level, meets the Server 38 requirement then the routine of FIG. 3 is complete and the process continues per FIG. 4. If not, the Client Software will require the User to Authenticate to the required level at step 58, before attempting to access the Server 38 per FIG. 4. In a simple implementation, step 58 will comprise a pop-up window to ask the User to provide a password for the necessary security level, which is compared to the stored password in the Owner_info section.

At this point, the User has authenticated to the Client Software. The Client Software now authenticates the transaction to the Server 38. The steps described with respect to FIG. 4 are executed as part of requesting access to the Server 38, identified as step 20 in FIG. 1.

As described above, the Password Data File contains a sequence of one time passwords using a non-reversible or hash function. For each sequence, there is a secret or seed, upon which a non-reversible or hash function is executed to generate the sequence.

At step 60, the Client Software identifies the Server_access_info in the Password Data File which provides the protocol required and the next_number_to_use to generate the password which will allow access to the Server 38; that is, the previous number in the non-reversible sequence. Of course, if the Password Data File is stored in an encrypted form, additional steps will be required to identify, load and executed the required decryption module associated with the Password Data File.

At step 62, the Client Software will then determine whether the next_number_to_use is equal to zero. This will indicate that the next password is iteration number zero in the sequence, and there are no more passwords available in the sequence after the present one is used. Since the hash sequence is used by counting down, the zero iteration will eventually be reached and no more passwords will be available. A new sequence can be generated and a new reference value sent to the Server 38 by re-keying. There are several ways to perform re-keying:

1. Simple rekeying

Along with the final password s₁, send a new s′₁₀₀

2. Linear multi-sequences

Start by giving several values initial values to the Server 38, such as a series S₁₀₀, S′₁₀₀, S″₁₀₀, . . . s⁽ⁿ⁾₁₀₀, then use each one in turn, essentially splicing the passwords together into a longer sequence.

3. Multi-sequence re-keying

This combines the two above techniques so that the product of the lengths is obtained rather than the sum of the lengths. This also allows the sequences to be treated as different security levels so that higher-level sequences may be used to rekey lower-level ones.

For example, a sequence of 100 rekeying values providing seeds for sequences of 100 one-time passwords would result in 100×100=10,000 one- time passwords.

If rekeying is determined in the fashion of item 3 above, the next_rekey_number_to_use, that is, the re-key number in the sequence, will be obtained at step 64, and a new sequence of passwords will be generated at step 66.

The new sequence of passwords generated is now stored along with other relevant data, such as: next rekey_number_to_use, rekey_hash_value, new_last_hash_in_normal, new_next_number, in the Password Data File at step 68. As noted above, this data will be encrypted if required by the local security policy.

The Client Software then decrements the counter next_rekey number_to_use and sets next_number_to_use=100 (or whatever is chosen as sequence length), and stores this data in the Password Data File.

The authentication information is then sent to the Server 38 as indicated at step 72. If a new sequence of password had been created at steps 64 through 70, then a new initial value from this sequence is sent as part of this package.

Note that if a new initial value has been sent with this packet, there is a possibility that the packet could be intercepted and the new initial value modified, which will would allow an intruder to shut out the Client 34 and have access himself to the Server 38. Therefore, it is recommended that a standard encryption technique such as Secure Sockets Layer (SSL) be used to protect this communication. This is a protocol that provides both authentication and encryption for transmission over a TCP/IP (Transmission Control Protocol over Internet Protocol) network.

Standard encryption techniques could also be used to complement non-repudiation features of the invention. For example, if only one hash value has been used in a rekeyed sequence and a network error causes synchronization to be lost with the Server, the Client may have to rekey with the Server. This could allow the Server to claim the full 100 passwords or “coins” of the lost sequence, rather than just the single coin, by generating a new hash sequence to replace the lost one. Confirmation back to the Client in a cryptographic form, would prevent such a problem. This technique could also be useful in cases of pre-mature re-synchronization and other error conditions.

Such cheating can be prevented if the initial setup and each rekeying is required to be cryptographically signed by the User, using techniques known in the art. Without such signings, the analysis becomes more complicated and the implementation of the invention needs more care.

Returning briefly to step 62, if the Client Software has determined that the next_number_to_use is greater than zero, indicating that further passwords will be available in the sequence after the present one is used, then it is only necessary to determine the next value to be sent as a password, at step 74, and to decrement the next_number_to_use at step 76, storing it in the Password Data File. The appropriate password is then transmitted to the Server 38 at step 72 in the same manner as described above.

The transmission to the Server 38 at step 72 will include the transaction parameters along with the authentication info, the User identification (from the Owner_info section of the Password Data File) and the User-identity (from the Server_access_info). This completes the detailed description of step 20 of FIG. 1.

FIG. 5 now outlines the proposed steps to apply the invention in the preferred environment of an internet browser such as Netscape Navigator or Internet Explorer. An authentication request in such an environment may be handled automatically, in a manner well known in the art. In this example, authentication is handled with a new MIME (Multipurpose Internet Mail Extension) plug-in, for example, called x-WebPass.

HTTP (Hyper Text Transfer Protocol) is a stateless protocol, that is, information is not stored in a session at each of the two communicating sites. Therefore the browser plug-in will have to transfer the access information that has been gathered to that point, such as user name, server and service requested, with each communication. Two common techniques for implementing such transfers are appending such information to the URL, or using cookies to temporarily store the information. Both techniques are well known in the art and commonly supported by internet browsers.

Firstly, the User accesses the internet and identifies a website which requests authentication, as shown at step 74. In doing so, the browser transmits the identified URL (Universal Resource Locator) to the Server 38 at step 76, resulting in a response as to whether authentication is required. If the Server 38 does not require authentication to access the requested page, then the Client 34 is allowed access without authentication shown at step 78. If step 78 shows that authentication is required, then the Server 38 will send a page back which includes the x-Webpass tag, at step 80. The x-WebPass tag is essentially an authentication demand from the Server 38 to the User.

The User's Netscape Navigator will identify the x-Webpass tag and will invoke the Webpass plug-in at step 82, which collects the necessary identification and location information and invokes the Client Software to initiate the self-authentication and authentication to the Server 38 as outlined above.

Because the Netscape browser currently sends mouse-clicks to the Server automatically, the Server will receive such mouse clicks and prepare a challenge which it returns to the Client. Alternately, if a browser allows mouse-clicks to be grabbed, then the plug-in may simply receive the request from the Client and forward the request to the Server without an explicit challenge.

It is preferred that authentication be performed on a per-transaction basis, that is, with each transmission or set of transmissions from the Client 34 to the Server 38. In the case of browsing on the internet, there would be an authentication for each web-page that is requested by the Client 34. The invention is well suited for per-transaction authentication because of the low overhead and fast authentication at the Server 38 and because of the ease of automating the generation of one-time passwords at the Client 34.

Per-transaction authentication is in contrast to login sessions common in the art, which only require authentication at the beginning of each session. In more secure applications, authenticate at regular time or communication intervals may also be required. These methods leave the User open to “session attacks” where an intruder may access the Server by masquerading as the User during a session, or afterward if the User forgets to logout. Pre-transaction authentication in the manner of the invention makes it very difficult for an intruder to access the Serve.

This completes the description of the preferred embodiment of the invention_as executed by the First Computer Program 10. The corresponding operation of the Second Computer Program 12 will now be described in further detail.

Operation of the Second Computer Program 12, in broad terms, is to receive a password from the First Computer Program 10 in response to an authentication challenge, and responds to the non-reversible function operating upon the password being equal to the reference value by authenticating the First Computer Program 10 to the Second Computer Program 12. The password is then stored as the reference value for future authentications.

In general, the Second Computer Program 12 will be installed and executed by a Second Computer, typically a Server 38. FIG. 6 describes the operation of the Second Computer Program 12 with respect to how the Server 38 coordinates with the Client steps outlined above. When the Server 38 receives a transaction from a Client 34, the Server 38 hands the transaction to the Server Software, where a subroutine call may be made to a WebPass Application Programming Interface.

Firstly, the Server Software will unbundle the transaction into its constituent parts, at step 86. It will then refer to its internal database to determine whether the Client 34 exists in the User-File, at step 88. If the Client 34 is not found, a failure message is returned to the Client 34 at step 90 and the Server 38 leaves the authentication routine. In addition to indicating failure, this message may also advise instructions as to how the User might apply for authentication to the Server 38. As well, the Server 38 may record the identity of the User for information purposes, or to advise the User of the unsuccessful access attempt.

If the Server 38 does identify the Client 34 in the User-file at step 88, then the Server 38 will determine whether the request is a delegation request at step 92. If the request is a delegation request, then the Server will verify whether the password authenticates against the delegation sequence at step 94. If it does not, the failure is returned at step 90 as described above. If the password does authenticate against the delegation sequence, then the Server 38 adds the new User ID to the user File at step 96 and returns a success code at step 98.

If the request is not a delegation request, then it is a normal requestion and the User-identity has been found so all that remains is to verify the hash value against the reference value. At step 100, the incoming password is compared to the stored reference value by executing the non-reversible function on the incoming password in one of the manners outlined above. The incoming authentication_info will indicate which sequence data is to be used, generally either Normal, Rekey or Rekey2. If the Server Software is not able to authenticate the incoming password, then the Failure_Code is returned to the Client 34 at step 90.

If authentication is successful, then the User_file is updated with the new reference value and iteration number for the normal sequence at step 102.

If the Server Software recognizes that rekeying has been requested by the Client 34 at step 104, then the normal sequence of the User_file will be updated with the new reference value and iteration number corresponding to the rekey value at step 106, and the Success_code will be returned to the Client 34 at step 98. If rekeying is not requested, then the Server Software returns the Success_code to the Client 34 at step 98.

Once a secure session has been obtained as described with respect to FIG. 3-6 above, some minimal technique of encryption as known in the art, can be used to protect the less critical communication that occurs between the Client 34 and Server 38. Many techniques are known for providing such security, including SSL (Secure Sockets Layer).

The Password Data File contains the Client secrets used to access the corresponding Server or Servers. Normally this file would be encrypted using one of the techniques known in the art. A single key may be used to encrypt all Password Data Files and this key embedded in the Client Software and Client Tools Software. Different Users may have different encryption keys as well as ways of changing the keys to be used.

It is envisioned that the Password Data File have several sections:

1. Version_info

This section contains housekeeping information about the version of programs used to create and maintain this file, and the encryption key needed to use this file. This information is generally kept in plain-text, so that the encryption key may be accessed.

Keys may be changed by sending out new versions of Client Software that use the old key to read but the new key to write. This conversion can be achieved transparently, as is done by many programs for handling program upgrades.

Different companies may have different keys for their Password Data Files, by supplying their own module or DLL (Dynamic Load Library) that knows how to decrypt.

2. Owner_info

This section contains all the information about the User including all the authentication information and organizational affiliation. Basically, when the User authenticates himself to the Client Software, the User will authenticate against information stored in this section. In the simplest implementation, this part can be as simple as a name and a password. In more elaborate implementations, this section may contain biometric information, questions and answers created by the User, and organizational affiliations.

3. WebPass_info

This is the information particular to a given application of the Password Data File. For example, it may be “bound” to a particular computer or an IP address and the authentication requirement set to be lower when running on the bound computers. The particular “Security Policy” is also stored here, that is, each Server 38 may imposed security policies and they will be merged here.

4. Server_access_info

The section is used to store the access information for each of the Servers 38 accessible by this Password Data File. It will contain “User-identity” that is authorised, the name, address and function of the Server 38, the protocol preferred, security policy and Server-specific encryption keys. Each Server_access_info will also have version and possibly encryption information to allow the option of companies holding the keys for their Servers 38. The seeds or sequences used to authenticate to the Server 38 are also stored here.

For each hash-sequence, either the seed or the whole hash-sequence could be stored along with the next_number_to_use.

The information for each Server 38 may have several hash-sequences, each sequence for a different purpose, and can vary for different protocols and Servers 38. Typically, each Server 38 will have:

1. A “normal” authentication sequence

This is used for the normal transactions. Since this is the one used most often, it is most efficient to store this sequence as a computed array.

2. A “delegation” sequence

This is used to authenticate creation of delegates. Since this is not done frequently, this sequence will probably be computed from the stored seed as required.

3. A “rekeying” sequence

Since the normal sequence is finite, say in the order of 100 iterations, it may be quickly exhausted. Therefore a rekeying sequence may be used to authenticate the setting of a new normal sequence. The last hash in the normal sequence could be used to rekey, but complex protocol would be required to handle error conditions. Using a separate rekey sequence provides a simpler solution.

4. A “rekey2” sequence

Since the rekeying sequence is also finite, it may be exhausted as well. A “rekey2” sequence may be used rekey the rekeying sequence. Clearly, this can be repeated ad infinitum but in practice will rarely require more than the rekey2 sequence. If each normal, rekey and rekey2 sequence is 100 iterations in length, then this arrangement will provide one million, unique one time passwords. If one password is used per day, this sequence will provide approximately 30 years of passwords.

5. Encryption Keys

Optionally, the User's Public/private key pair and the Servers's 38 public key used for signing could be stored in this section.

The Client Software will generally be in several pieces, including self-authentication, Client-Server authentication and commonly used tools. There will also be pieces that interface to various applications. One example of such an application would be an internet browser, such as the Netscape Navigator plug-in running on Microsoft Windows, as described above.

Since it is desirable to only have a single copy of the Client Software running on the computer, it may be implemented as a DLL (Dynamic Load Library) on Windows. It will then be loaded as soon as anyone tries to use it and will stay loaded. The Client Software will “own” the Password Data Files and does all the reading and writing. The invocation interface can be the normal DLL invocation mechanism, or it can be protected with obfuscation software. The degree of protection is dependent on the intended market. Usually only authenticating the User to the Seller is of concern and there is no threat to the Client side, so there is no need to protect the invocation interface. In some more general schemes, it may be necessary to protect this invocation interface from intruders with obfuscation software.

The Server Software is really only managing User-identity since the authentication is essentially done in the Client 34 side. This is in contrast to the existing systems, where the authentication is done at the Server 38.

Server Software may be designed very much like network manager software known in the art, except that the routines used to authenticate may be simplified to apply the method of the invention.

A Client may have multiple User-identities, each having a complete set of hash-sequences and being authenticated independently. This would allow the Client to have different security policies for different computers, such as a laptop, office computer and home computer, possibly with different biometric access equipment. Rather than having all biometric data stored at a single location, the User may decide which are needed where, even when no single computer has all of the biometric equipment. Each User-identity is essentially a “Delegate” that was authorized by the Client, and comprises just a string of characters whose contents has no significance to the Server. It is suggested of course, that Users select meaningful strings, such as “FredSmith-laptop” or “FredSmith Delegated to JackSpratt”.

The Server Software may store all the User information as a flat-file, each User-identity being a single line including this_identity, owning_User, privileges, normalsequence(hash,number) and rekdy(). That is, for each User, the position and value of each of the hash sequences that was last used may be remembered. Optionally, the Server could store the User's public key used for signing.

Since this file is stored on the Server 38 and is never accessed by any other computer, there is no need to encrypt it. Obviously, this information could be encrypted if private information were stored there, but no private information is required at the Server, so there is no real need.

It is not necessary for the Server Software to send an explicit challenge to the Client. The Client may be configured to allow unilateral authentication without communicating with the Server 38, rather than authenticating in response to a Server 38 challenge as in traditional schemes. In such an arrangement, the Server 38 need only perform the final acceptance of the authentication. This is particularly useful for machines spread over slow links, or machines that are only occasionally connected over one way media, and also allows many operations to be done purely at the Client end such as delegation.

The Client Tools are intended to be stored on Client 34 computers and to provide a number of different operations. These functions may be implemented as separate tools, or be included in the Client Software. In practice, many of these functions will be implemented in the Client Software, and the tool is merely the User-interface to activate the routine.

1. Creating a new Password Data File for a new User

This is done by creating a new empty Password Data File, then filling in the owner_info section. Conceptually, the User could add authentication information separately though the local policy, which could mandate that each Password Data File be created to some minimum level of authentication. A sensible minimum would be to have a password and some number of questions and answers.

2. Changing Password Data File owner info or lost passwords

This is done by reading in the Password Data File, authenticating the User with existing information in the file, adding or changing information as requested, then writing out the new file. One primary use for this tool is handling lost passwords, while another is to add biometric authentication information. Optionally, a User could create a Password Data File, then go to different computers to add different biometrics. Because the User is only providing means to authenticate himself to his Client Software, the information never leaves his Password Data File and is not stored anywhere else.

3. Accessing a new Server

When a User wants to access a new Server 38, this tool will open and decrypt the Password Data File, and add a new Server_access_info section. All the required seeds may be generated randomly and automatically. The new information is then written to the Password Data File, encrypted if necessary, and stored. As well as updating the Password Data File, this tool will generate an “access coupon” file which contains the information to be entered into the Server's

User-file. Generally, this comprises the User identification and initial hash values.

The User will give this coupon file to the Server, who will verify the User's identity by means known in the art, such as checking a photo-badge, driver license, or similar identification. If the initial authentication is successful, the System Administrator will run the Server Software to add the coupon into the User-file. Depending on the requirements, it may be useful to have the User and Server 38 electronically sign the coupon file. This is not necessary for the invention, but may be useful for later dispute resolution. The Client Software will also update the Password file appropriately. In cases of mutual authentication, the Server 38 will return a “stamped coupon” file that needs to be included in the User's Password Data File.

4. Delegation

When invoked, the delegator's Client Tools will create a “delegation coupon” that contains the from-User, to-User, duration, restrictions and other information, and transmit the coupon to the delegatee who will just merge it into his own Password Data File. For the duration of the delegation, the delegatee can then access the Server 38 to perform whatever functions have been delegated, and will be identified as a delegatee of the delegator. Of course, the delegator will have to self-authenticate to a level at least as high as the level being delegated to. Optionally, the delegator will be able to select the security level that the delegatee may access. Optionally, the delegatee can create a new access coupon using his Client Tools, and hand it to he Server 38 along with the delegation coupon. The Server 38 then verifies the delegation and creates, in effect, a new User. It is up to the Server 38 to decide if delegation is allowed. The decision could be implemented as a policy enforced at the Client 34, or delayed until an actual access attempt and then the Server 38 can decide on a case by case basis.

5. Multiple Password Data Files for a single User

A User might have access to many different Servers 38 and want to be abler to access different subsets from different computer. For example, from the computer at work, everything is allowed, from the computer at home, all but the most sensitive capabilities are usable, and from the laptop on the road, only routine, low-security functions can be performed.

To create multiple Password Data Files for a single User, the User merely creates new Password Data Files as needed. Presumably, the identification of each Password Data File will be representative of the use, to reminder the User of the application. For example: “FredSmith-laptop” and “FredSmith-home”. The User can choose to use the same “Owner-info” for all the copies, or he could choose to have different authentication mechanisms for each instance. Clearly, the former is more convenient, while the latter can be more secure.

The User then delegates whatever privileges desired into each instance.

Normally, one would expect the User to keep one as the “Master” and add all new accesses into this master, and then delegate from the master to the instances. This makes it easy to handle losing the laptop, for example, by just revoking all delegations to that instance.

Note that this is controlled on the Client side, and each Server 38 only deals with the delegations that affect it. As in delegation, there is minimal incremental cost to the Server 38 other than a little disk space to hold the additional User information.

Each of the multiple Password Data Files may have individual security policies and be “bound” to the respective computer. Optionally, each Password Data File could have different passwords and secrets and each could have a different set of biometrics. This maximized protection is at the cost of losing the Single-signon convenience of the invention.

Similarly, the Server Tools are intended to be stored on the Servers 38 and to provide additional administrative functions. Of course, these functions may also be included in the Server Software, or even stored in a Client 34 computer to administer their delegates.

1. Server Delegation

Quite often, a service is implemented by multiple Servers 38. For example, a large corporation could have a server at a head office at one location, with additional servers at national and regional offices in other locations. When a User first uses a service, the Master Server will re-direct the User to a Local or Secondary Server. The Master Server essentially delegates the User to the Local Server.

The re-direction, depending on the Client 34 and Server Software, could be automatic or could require User intervention. The Servers will have previously set up the relationship.

2. Cancel User

Users may be cancelled in a manner as known in the prior art. Typically, this is as simple as deleting the User_file.

3. Identify and track delegatee

It is a straightforward task to add the tracking of delegatees to existing Administrative Software because the invention provides delegatees with a separate identity. In the prior art, the delegatees assumed the identity of the delegator and could not be distinguished. Therefore, in the prior art, delegatees could not be identified and tracked.

4. Directory Administration

Functions are provided to create and administer libraries of Users. If a User has a directory of employees or a Public-Key Infrastructure, the server code may be configured to access the directory for the initial authorization of the User. For example, the Server could poll the directory once a day to confirm that the User is still an employee. The Server could also have a “notification” service linked to the directory to receive notices of changes to employee access.

5. Accounting/Billing

Because the invention allows user and delegate access to be monitored completely, detailed bills and usage reports are easily generated. A complete set of tools for accounting and billing may be employed, limited only by the User's requirements and data storage capacity.

### Applications

The invention provides for a broad range of applications beyond simple authentication of a Client to a Server. One skilled in the art could easily implement such applications given the teachings of the invention. Examples of such applications include:

1. Information reseller

The invention is easily applied as an intermediary to control and monitor access of delegatees. For example, a Reseller could set up an account with a Vendor who has a website. The Reseller then delegates access to Users who wish to make purchases from the Vendor. The Reseller can easily track and control the access and purchases of the Users, setting limits and withdrawing their access if necessary.

Similarly, the Vendor may control the access and credit limit of the Reseller.

2. Vendor “franchise”

A combination of “User Delegation” and “Server Delegation” may be used to allow the members of two large groups to interact at a local level. Each member of the Master User can be made a delegate of the Master User, and each Local Server of the Master Server, be made a delegate of the Master Server.

An employee at a new location of the Master User would transact with the Master Server to find the correct local Server, then establish access to that Local Server. Each subsequent transaction between the employee and the Local Server is then trackable by the Master Server to the Master User account, and similarly, the Master User can break down the usage by employee.

3. Milli-cent commerce

The invention has many applications in the “milli-cent e-commerce” area. One such application is to treat each successive password as a “coin” of some fixed denomination. It is not the value of the password that is significant, but the quantity of passwords.

Because the passwords are finite and verifiable, the User cannot forge the number of coins. Also, because new passwords can only be generated by the User, no intruder can steal the User's coins. Both of these features are a result of the non-reversible property of the hashing function.

4. Milli-cent broker

The milli-cent e-commerce application described in item 3 above may be applied to a broker who serves as an intermediary allowing Users to make purchases from a large number of web sites that the broker is authorized at..

5. Roaming

With server delegation, a user may sign up locally, and obtain access globally, in much the same way as cellular phones are implemented.

6. Varying Security Policies

Each Server may have different requirements for authentication. The invention provides for the flexibility to dictate the minimum security level either from the Server Software, or the Client Software. Because the Client Software can keep track of the requirements of the different Servers, the invention allows several Servers to be satisfied by authenticating once. Possible security policies include:

a. That access is only valid for a finite period of time, the Server requesting re-authentication periodically.

b. Finger print or other biometric information.

c. A special hardware token is required, such as a smartcard.

d. Authentication is valid as long as activity is continuous, to ensure that the User has not walked away from the terminal.

e. Combinations of biometrics and simple passwords, with different time-outs.

f. Password authentication is acceptable as long as the password is long enough and changed every month.

g. An E-mail Server typically requires a higher level of security to protect privacy. The popular POP3 protocol requires the User password at the start of each session. Some proprietary E-mail systems require the User the enter the password only once a day, while the Software remembers it in an encrypted form on the computer.

### Additional Embodiments

One skilled in the art would recognize that a great number of additional options and embodiments. It would be clear to one skilled in the art how to employ such options, based on the teachings of the invention. This list is not intended to be exhaustive, but could include:

1. “20 questions self-authentication”

When the User creates his Password Data File, he could enter a large number of questions and the matching answers. The key is that each question need only be meaningful to the User and elicit the matching answer (“matching” can be exact or be some other measure of closeness). The authentication is then a challenge-response game where the computer picks random questions and checks for correct responses.

2. Binding to computers or Internet Protocol addresses

The use of a Password Data File may be limited to a particular computer, set of computers or IP (Internet Protocol) address by writing the computer information into the Password Data File. Thereafter the Client Software will refuse to accept that Password Data File except on an “bound” computer. The binding can be on computer names, network address, serial number, etc. Because the invention provides for multi-level authentication, one could, for example, store a Password Data File on a portable diskette and set up the binding as follows (for low-level access):

for low-level access on the User's main desktop-computer at work, no password is needed,

for low-level access on the User's portable laptop computer, a simple password is needed.

for low-level access on other computer, a medium password is needed.

3. Multiple Domains

Domains are described as sets of computers that are administered together. Typically all the computers that are in one company or workgroup, comprise a domain. However, a large company may wish to establish multiple domains within its network to control access to the different domains. The invention easily provides for such control by allowing multiple encryption keys. As described above, each Password Data File contains a header with data such as the edition of the Software that created the Password Data File, the edition of the format and which encryption key was used to decrypt the Password Data File.

In a general application, only one key is used to encrypt the Password Data File, which is embedded in the Client Software. This key could be protected against local intrusion by use of obfuscation software or other techniques known in the art. This means that the vendor of the Client Software would possibly be able to read and decode any Password Data File. A large company may want to pick their own encryption keys to encrypt the information, either for their Servers and/or their internal Clients. These keys will be embedded in the Client Software and again protected against local intrusion. When a Server is added to a Password Data File, the Client Software will invoke a tool to decrypt and encrypt the Password Data File as needed. The large company may control how the key is stored and how strong to make the protection of the key. In the extreme, each piece of information could be encrypted by a different key chosen by a different party.

4. Tracking

The invention easily allows the Client Software to continuously track the state of authentication.

5. Mutual Authentication

For most applications, it is necessary only for the User to authenticate himself to the Server 38. In some applications, however, it may be useful for the Server 38 to authenticate to the Client 34 as well, which is described as Mutual Authentication. The invention is easily applied to such a protocol by running two copies of the Client and Server Software, one pair in each direction.

Alternatively, the Client Software could store the public key of the Server 38, allowing all requests to be encrypted as only the real Server 38 can decrypt the request with the corresponding private key. In combination with technologies such as SSL, it is fairly easy to be secure.

Mutual authentication is useful for important transactions such as re-keying, where there is a possibility that information may be intercepted.

While particular embodiments of the present invention have been shown and described, it is clear that changes and modifications may be made to such embodiments without departing from the true scope and spirit of the invention.

It is understood that as communication networks become more flexible and powerful, the definitions of servers, computers, LANs, WANs and other hardware components are becoming less and less clear. These terms have been used herein to simplify the discussion and do not strictly limit the invention to the former definitions of such hardware. For example, the administrative control of a local network may be allocated to what would be described as a standard computer, rather than a server. Clearly this administrative computer could assume the role of the server in the context of the invention, by controlling access of the other computers in the network.

Similarly, telephony hardware is beginning to perform more intelligent control of data communications. Again, implementing the invention with such telephony hardware clearly does not take away from the invention.

These embodiments may be executed by a computer processor or similar device programmed in the manner of method steps, or may be executed by an electronic system which is provided with means for executing these steps. Similarly, an electronic memory means such computer diskettes, CD-Roms, Random Access Memory (RAM) and Read Only Memory (ROM) may be programmed to execute such method steps. As well, electronic signals representing these method steps may also be transmitted via a communication network.

The sets of executable machine code representative of the method steps of the invention may be stored in a variety of formats such as object code or source code. Such code is described generically herein as programming code, or a computer program for simplification. As well, the executable machine code may be integrated with the code of other programs, implemented as subroutines, by external program calls or by other techniques as known in the art.

It would also be clear to one skilled in the art that this invention need not be limited to the existing scope of computers and computer systems. Credit, debit, bank and smart cards can be encoded to apply the invention to their respective uses. An authentication system in a manner of the invention could also be applied to inventory control, personal identification, security passes, electronic keys on hotel rooms, apartment buildings, car doors and mailboxes using magnetic strips or electronic circuits to store the passwords. Again, such implementations would be clear to one skilled in the art, and do not take away from the invention.

What is claimed is:

1. A method of authenticating communication between a first set of machine executable code and a second set of machine executable code, wherein both said first set of machine executable code and said second set of machine executable code are operable to execute a like non-reversible function, said first set of machine executable code has established an account with said second set of machine executable code by transmitting an initial value to said second set of machine executable code calculated by at least one iteration of a non-reversible function on a stored seed value, said method comprising the step within said first set of machine executable code of:
responding to an authentication challenge from said second set of machine executable code by transmitting to said second set of machine executable code a password calculated by fewer iterations of said non-reversible function on said stored seed value than used to calculate said reference value, and storing the quantity of said fewer iterations.

2. A method of authentication as claimed in claim 1 wherein said step of responding to an authentication challenge comprises the step of:
responding to an authentication challenge from said second set of machine executable code by transmitting to said second set of machine executable code a password calculated by a predetermined number of fewer iterations of said non-reversible function on said stored seed value than used to calculate said reference value, and storing the quantity of said fewer iterations.

3. A method of authentication as claimed in claim 2 wherein said step of responding to an authentication challenge comprises the step of:
responding to an authentication challenge from said second set of machine executable code by transmitting to said second set of machine executable code a password calculated by one fewer iterations of said non-reversible function on said stored seed value than used to calculate said reference value, and storing the quantity of said one fewer iterations.

4. A method of authentication as claimed in claim 3 comprising the step of:
transmitting to said second set of machine executable code a new initial value calculated by at least one iteration of said non-reversible function on a new seed value.

5. A method of authentication as claimed in claim 4 wherein said first set of machine executable code resides in a first computer and said second set of machine executable code resides in a second computer, said first and second computers being linked by a communication network, and each step of transmitting comprises a step of transmitting via said communication network.

6. A method of authenticating communication between a first set of machine executable code and a second set of machine executable code, wherein both said first set of machine executable code and said second set of machine executable code are operable to execute a like non-reversible function, said first set of machine executable code has established an account with said second set of machine executable code by transmitting an initial value to said second set of machine executable code calculated by at least one iteration of a non-reversible function on a stored seed value, said first set of machine executable code resides in a first computer and said second set of machine executable code resides in a second computer, and said first and second computers are linked by a communication network, said method comprising the step within said first set of machine executable code of:
responding to an authentication challenge from said second set of machine executable code by transmitting to said second set of machine executable code via said communication network, a password calculated by one fewer iterations of said non-reversible function on said stored seed value than used to calculate said reference value, and storing the quantity of said one fewer iterations; and
transmitting to said second set of machine executable code via said communication network, a new initial value calculated by at least one iteration of said non-reversible function on a new seed value.

7. A method of authentication as claimed in claim 6 wherein said first computer has established an account with said second computer by transmitting a plurality of initial values to said second computer calculated by at least one iterations of a non-reversible function on a plurality of stored seed values, and said step of responding to an authentication challenge comprises the step of:
responding to an authentication challenge from said second set of machine executable code by successively transmitting to said second set of machine executable code via said communication network, a password calculated by one fewer iterations of said non-reversible function on one of said plurality of stored seed values than used to calculate said plurality of initial values, and storing the quantity of said one fewer iterations for the respective one of said plurality of stored seed values.

8. A method of authentication as claimed in claim 7 further comprising the prior step of:
calculating a plurality of new seed values by multiple iterations of a non-reversible function on an initial seed value; and
said step of transmitting to said second set of machine executable code via said communication network, a new reference value comprises transmitting to said second set of machine executable code via said communication network, a new reference value calculated by multiple iterations of said non-reversible function on one of said plurality of new seed values.

9. A method of authentication as claimed in claim 8 wherein said second computer delegates access to a third computer, said third computer linked to said first and second computers via said communications network, by performing the step of:
responding to a request for delegation of access to said second computer by said third computer by transmitting to said third computer via said communications network a password corresponding to one fewer iterations of said non-reversible function than used to calculate said reference value.

10. A method of authentication as claimed in claim 9 wherein said communication network comprises an internet communications protocol network and each said step of transmitting comprises a step of transmitting via said internet communications protocol network.

11. A method of authentication as claimed in claim 10 comprising the step of:
responding to an authentication challenge by transmitting to said second computer via said internet communications protocol network the quantity of iterations of said non-reversible function used to calculate said password.

12. A method of authenticating communication between a first set of machine executable code and a second set of machine executable code, wherein both said first set of machine executable code and said second set of machine executable code are operable to execute a like non-reversible function, said first set of machine executable code has established an account with said second set of machine executable code by transmitting an initial value to said second set of machine executable code calculated by at least one iteration of a non-reversible function on a stored seed value, said method comprising the steps within said second set of machine executable code of:
receiving a password from said first set of machine executable code in response to an authentication challenge;
responding to said non-reversible function operating upon said password being equal to said reference value by authenticating said first set of machine executable code to said second set of machine executable code; and
storing said password as said reference value.

13. A method of authentication as claimed in claim 12 wherein said step of responding comprises responding to said non-reversible function operating upon said password a predetermined number of iterations being equal to said reference value by authenticating said first set of machine executable code to said second set of machine executable code.

14. A method of authentication as claimed in claim 13 wherein said step of responding comprises responding to said non-reversible function operating upon said password by one iteration being equal to said reference value by authenticating said first set of machine executable code to said second set of machine executable code.

15. A method of authentication as claimed in claim 14 comprising the step of responding to receipt of a new initial value by storing said new initial value calculated by at least one iteration of said non-reversible function on a new seed value, as said reference value.

16. A method of authentication as claimed in claim 15 wherein said first set of machine executable code resides in a first computer and said second set of machine executable code resides in a second computer, said first and second computers being linked by a communication network, and each said step of receiving comprising receiving via said communication network.

17. A method of authenticating communication between a first set of machine executable code and a second set of machine executable code, wherein both said first set of machine executable code and said second set of machine executable code are operable to execute a like non-reversible function, said first set of machine executable code has established an account with said second set of machine executable code by transmitting an initial value to said second set of machine executable code calculated by at least one iteration of a non-reversible function on a stored seed value, said first set of machine executable code resides in a first computer and said second set of machine executable code resides in a second computer, and said first and second computers are linked by a communication network, said method comprising the step within said second set of machine executable code of:
receiving a password from said first set of machine executable code via said communication network in response to an authentication challenge;
responding to said non-reversible function operating upon said password by one iteration being equal to said reference value by authenticating said first set of machine executable code to said second set of machine executable code;
storing said password as said reference value; and
responding to receipt of a new initial value by storing said new initial value calculated by at least one iteration of said non-reversible function on a new seed value, as said reference value.

18. A method of authentication as claimed in claim 17 wherein said first computer has established an account with said second computer by transmitting a plurality of initial values to said second computer calculated by at least one iteration of a non-reversible function on a plurality of stored seed values, and said step of responding to said non-reversible function comprises the step of:
responding to said non-reversible function operating upon one of said plurality of passwords by one iteration being equal to a corresponding one of said reference values by authenticating said first set of machine executable code to said second set of machine executable code.

19. A method of authentication as claimed in claim 18 wherein access may be delegated to a third computer, said third computer linked to said first and second computers via said communication network, by responding to said non-reversible function operating upon said delegation password by one iteration being equal to said reference value by authenticating said third computer as a delegate of said first computer.

20. A method of authentication as claimed in claim 19 wherein said communication network comprises an internet communications protocol network and each said step of receiving comprises a step of receiving via said internet communications protocol network.

21. A method of authentication as claimed in claim 20 wherein said first computer is operable to transmit the quantity of iterations used to calculate said initial value and said password, and said second computer is operable to receive and store said quantity of iterations, said step of responding to said non-reversible function comprising responding to said non-reversible function operating upon one of said plurality of passwords the number of times equal to the difference between said quantity of iterations to calculate said reference value and said quantity of iterations to calculate said password, being equal to said reference value by authenticating said first set of machine executable code to said second set of machine executable code.

22. A computer readable storage medium storing a first set of machine executable code, said first set of machine executable code being executable by a computer to perform the step of:
responding to an authentication challenge from a second set of machine executable code by transmitting to said second set of machine executable code a password calculated by fewer iterations of a non-reversible function on a stored seed value than used to calculate a reference value, and storing the quantity of said fewer iterations.

23. A computer readable storage medium as claimed in claim 22 wherein said step of responding to an authentication challenge comprises the step of:
responding to an authentication challenge from said second set of machine executable code by transmitting to said second set of machine executable code a password calculated by a predetermined number of fewer iterations of said non-reversible function on said stored seed value than used to calculate said reference value, and storing the quantity of said fewer iterations.

24. A computer readable storage medium as claimed in claim 23 wherein said step of responding to an authentication challenge comprises the step of:
responding to an authentication challenge from said second set of machine executable code by transmitting to said second set of machine executable code a password calculated by one fewer iterations of said non-reversible function on said stored seed value than used to calculate said reference value, and storing the quantity of said one fewer iterations.

25. A computer readable storage medium as claimed in claim 24 wherein said first set of machine executable code is further operable to perform the step of:
transmitting to said second set of machine executable code a new initial value calculated by at least one iteration of said non-reversible function on a new seed value.

26. A computer readable storage medium as claimed in claim 25 wherein each step of transmitting comprises a step of transmitting via a communication network.

27. A computer readable storage medium storing a second set of machine executable code, said machine executable code being executable by a computer to perform the steps of:
receiving a password from a first set of machine executable code in response to an authentication challenge;
responding to a non-reversible function operating upon said password being equal to a reference value by authenticating said first set of machine executable code to said second set of machine executable code; and
storing said password as said reference value.

28. A computer readable storage medium as claimed in claim 27 wherein said step of responding comprises responding to said non-reversible function operating upon said password a predetermined number of iterations being equal to said reference value by authenticating said first set of machine executable code to said second set of machine executable code.

29. A computer readable storage medium as claimed in claim 28 wherein said step of responding comprises responding to said non-reversible function operating upon said password by one iteration being equal to said reference value by authenticating said first set of machine executable code to said second set of machine executable code.

30. A computer readable storage medium as claimed in claim 29 wherein said second set of machine executable code is further operable to perform the step of:
responding to receipt of a new initial value by storing said new initial value calculated by at least one iteration of said non-reversible function on a new seed value, as said reference value.

31. A computer readable storage medium as claimed in claim 30 wherein each said step of receiving comprises a step of receiving via a communication network.

32. A system for authenticating communication comprising:
a first set of machine executable code;
a second set of machine executable code;
said first set of machine executable code and said second set of machine executable code having means for executing a like non-reversible function; and
said first set of machine executable code having:
means for establishing an account with said second set of machine executable code by transmitting an initial value to said second set of machine executable code calculated by at least one iteration of a non-reversible function on a stored seed value; and
means for responding to an authentication challenge from said second set of machine executable code by transmitting to said second set of machine executable code a password calculated by fewer iterations of said non-reversible function on said stored seed value than used to calculate said reference value, and storing the quantity of said fewer iterations.

33. A system of authentication as claimed in claim 32 wherein said means for responding to an authentication challenge comprises:
means for responding to an authentication challenge from said second set of machine executable code by transmitting to said second set of machine executable code a password calculated by a predetermined number of fewer iterations of said non-reversible function on said stored seed value than used to calculate said reference value, and storing the quantity of said fewer iterations.

34. A system of authentication as claimed in claim 33 wherein said means for responding to an authentication challenge comprises:
means for responding to an authentication challenge from said second set of machine executable code by transmitting to said second set of machine executable code a password calculated by one fewer iterations of said non-reversible function on said stored seed value than used to calculate said reference value, and storing the quantity of said one fewer iterations.

35. A system of authentication as claimed in claim 34 wherein said first set of machine executable code comprises:
means for transmitting to said second set of machine executable code a new initial value calculated by at least one iteration of said non-reversible function on a new seed value.

36. A system of authentication as claimed in claim 35 comprising:
a first computer having means for executing said first set of machine executable code;
a second computer having means for executing and said second set of machine executable code; and
a communication network linking said first and second computers, wherein each means for transmitting comprises means for transmitting via said communication network.

37. A system for authenticating communication comprising:
a first set of machine executable code;
a second set of machine executable code;
said first set of machine executable code and said second set of machine executable code having means for executing a like non-reversible function; and
said second set of machine executable code being having:
means for receiving a password from said first set of machine executable code in response to an authentication challenge;
means for responding to said non-reversible function operating upon said password being equal to said reference value by authenticating said first set of machine executable code to said second set of machine executable code; and
means for storing said password as said reference value.

38. A system of authentication as claimed in claim 37 wherein said means for responding comprises means for responding to said non-reversible function operating upon said password a predetermined number of iterations being equal to said reference value by authenticating said first set of machine executable code to said second set of machine executable code.

39. A system of authentication as claimed in claim 38 wherein said means for responding comprises means for responding to said non-reversible function operating upon said password by one iteration being equal to said reference value by authenticating said first set of machine executable code to said second set of machine executable code.

40. A system of authentication as claimed in claim 39 wherein said second set of machine executable code further comprises means for responding to receipt of a new initial value by storing said new initial value calculated by at least one iteration of said non-reversible function on a new seed value, as said reference value.

41. A system of authentication as claimed in claim 40 comprising:
a first computer having means for executing said first set of machine executable code;
a second computer having means for executing and said second set of machine executable code; and
a communication network linking said first and second computers, wherein each means for transmitting comprises means for transmitting via said communication network.
